(19) United States
(12) Patent Application Publication
(10) Pub. No.: US 2003/0185729 A1
(43) Pub. Date: Oct. 2, 2003

(54) Electrode assembly for processing a semiconductor substrate and processing apparatus having the same

(76) Inventors: Ho Ko, Suwon-si (KR); Chang-Bong Song, Suwon-si (KR); Joong-Mo Lee, Gwangyeok-si (KR); Hyung-Seok Choi, Suwon-si (KR)

Correspondence Address: VOLENTINE FRANCOS, P.L.L.C., Suite 150, 12200 Sunrise Valley Drive, Reston, VA, 20191, US

(21) Appl. No.: 10/298,075

(22) Filed: Nov. 18, 2002

(30) Foreign Application Priority Data
Mar. 29, 2002 (KR) 2002-17493
Jun. 19, 2002 (JP) 2002-34312

(51) Int. Cl. B01J 19/08; B01J 19/12

(52) U.S. Cl. 422/186.05; 422/186.29

(57) ABSTRACT

An electrode assembly connected to a radio frequency electrical power source transforms process gas into plasma for processing a semiconductor substrate. The electrode assembly includes a first and a second electrode made of aluminum (Al), and a third electrode made of silicon (Si). A plurality of first bolts connect the first electrode to the second electrode, and a plurality of second bolts connect the second electrode with the third electrode. The bolts are either mad of or coated with a metal having an electric conductivity that is no less than that of the aluminum (Al). Furthermore, a conductive film and/or adhesive is interposed between the first electrode and the second electrode. The conductive film includes metal having an electric conductivity more than the aluminum (Al). The conductive film and the bolts reduce the electrical resistance throughout the assembly, and the adhesive fills minute apertures in the surfaces of the electrodes. Accordingly, arc discharges are prevented from occurring within the electrode assembly.

### BACKGROUND OF THE INVENTION

1. Field of the Invention

The present invention relates to an electrode assembly for processing a semiconductor substrate and to a processing apparatus comprising the same. More particularly, the present invention relates to an electrode assembly that is connected to a radio frequency (hereinafter, referred to as RF) power source so as to produce plasma for processing the semiconductor substrate and to a processing apparatus comprising the same.

2. Description of the Related Art

Generally, a semiconductor device is manufactured by repeatedly carrying out a variety of unit processes, such as deposition, photolithography, etching, ion implantation, polishing, cleaning and drying processes. The deposition process is used for depositing various thin material films or layers onto the semiconductor substrate, and is classified according to the different kinds of layers that may be deposited. The etching process is used for removing a particular portion of a layer to form a pattern having particular electrical characteristics. Recent depositing or etching technology uses a process gas in a plasma state, which will be simply referred to as plasma. Plasma is widely used in various processes in the manufacturing of semiconductor devices, particularly in the deposition and etching processes.

The process gas for processing the semiconductor substrate is changed by a RF power source including an RF generator and a RF matching device, and by an electrode assembly installed in a processing chamber. One example of such an electrode assembly is disclosed in U.S. Pat. No. 6,194,322 to Lilleland, et al. The electrode assembly comprises a support in the form of a graphite ring, a disk-shaped electrode, and a connecting member made of rubber. Furthermore, U.S. Pat. No. 6,173,673, issued to Golovato, et al, discloses a showerhead used in transforming the process gas into a plasma.

Generally, the electrode assembly usually comprises a first electrode and a second electrode, and may comprise a first, a second and a third electrode if necessary. The electrodes are integrated in the electrode assembly by fasteners such as bolts. The process gas is introduced into the processing chamber through the electrode assembly.

FIG. 1 shows a conventional electrode assembly.

Referring to FIG. 1, a first electrode 102 in the form of a disk shape is connected with an RF power source 101. A first penetrating hole 102a is formed at a central portion of the first electrode 102 for allowing a process gas to flow through the first electrode 102. A second disk-shaped electrode 104 has the same radius as the first electrode. The second electrode 104 also has a coupling portion 104a protruding along the periphery of a first surface of the second electrode 104 that faces the first electrode 102. A plurality of second penetrating holes 104b extend uniformly through the second electrode 104 radially inwardly of the coupling portion 104a, so that the process gas flowing through the first penetrating hole 102a is uniformly supplied into a processing chamber (not shown) via the holes 104b. A third electrode is 106 is disposed against the second major surface of the second electrode 104. The third electrode 106 includes a plurality of third penetrating holes 106a corresponding to the second penetrating holes 104b.

The first electrode 102 and the second electrode 104 are connected to each other by a plurality of first bolts 108 disposed along the peripheral portions of the first and the second electrodes 102 and 104. In addition, the second electrode 104 and the third electrode 106 are connected to each other by a plurality of second bolts 110 disposed along the peripheral portions of the second and the third electrodes 104 and 106. The first and second electrodes 102 and 104 are made of aluminum (Al), and the third electrode 106 is made of silicon (Si). On the other hand, the first and second bolts 108 and 110 are made of stainless steel.

When the RF electric power is provided to the electrode assembly 100 for transforming the process gas into a plasma, an abnormal discharge of electricity, such as an arc, is generated in a discharge space formed between the first electrode 102 and each of the first bolts 108, between the second electrode 104 and each of the first bolts 108, and between the second electrode 104 and each of the second bolts 110. The abnormal discharge results from a difference in electrical conductivity between the aluminum (Al) of the first and second electrodes 102 and 104 and the steel of the first and second bolts 108 and 110. Practically speaking, the electrical conductivity of the steel is lower than that of the aluminum. The abnormal discharge damages surfaces the first and second electrodes 102 and 104. FIGS. 2 and 3 show an example of a damaged surface (A) of the second electrode 104 around a first bolt-accommodating hole 104c.

Furthermore, when the electrode assembly 100 is used for a long time, the abnormal discharge is generated over the entire region where the surfaces of the first and second electrodes 102 and 104 contact each other. As a result, these surfaces of the first and second electrodes 102 and 104 are damaged. More specifically, a large number of minute apertures 10 are present in the surfaces of the first and second electrodes 102 and 104, as shown in FIG. 4. The abnormal discharge is generated in the apertures 10, whereby the surfaces of the first and second electrodes 102 and 104 are damaged.

Once the surfaces of the electrode are damaged, many particles are separated from the damaged surfaces (A), and are introduced into the processing chamber through the second the third penetrating holes 104b and 106a. Therefore, the semiconductor substrate is contaminated. In addition, the abnormal discharge impedes the RF matching, which results in the instability of the plasma in the processing chamber. The unstable plasma causes the patterns or the layers formed on the semiconductor substrate to be non-uniform. Furthermore, the abnormal discharge shortens the useful life of the electrode assembly and of the processing apparatus that employs the electrode assembly.

### SUMMARY OF THE INVENTION

An object of the present invention is to solve the above-described problems of the related art. Therefore, a first object of the present invention is to provide an electrode assembly comprising a pair of adjacent and connected first and second electrodes and in which assembly hardly gives rise to the occurrence of arc discharges. Similarly, another object of the present invention is to provide a method of making an electrode assembly that is not prone to producing arc discharges while in use. Likewise, still another object of the present invention is to provide a processing apparatus having an electrode assembly which assembly hardly gives rise to the occurrence of arc discharges.

In addition to the electrode assembly, the processing apparatus has a processing chamber in which the semiconductor substrate is processed, a chuck disposed in the processing chamber for supporting a semiconductor substrate, a gas supply part for supplying process gas for processing the semiconductor device, and an exhaust system for exhausting process gases that do not react with the substrate and by-products generated during the process to thereby control the pressure within the processing chamber.

The electrode assembly is connected to the gas supply part so as to receive a supply of process gas therefrom. The first electrode of the electrode assembly is connected to a high-frequency electrical power source for transforming the process gas into plasma and has a first penetrating hole through which the process gas flows The second electrode has a plurality of second penetrating holes for uniformly supplying the process gas flowing through the first electrode into the processing chamber.

The first electrode and the second electrode can be combined with one or more fasteners such as bolts. When the first electrode and the second electrode are each made of aluminum (Al), the bolts may comprise silver (Ag), copper (Cu), gold (Au), or aluminum (Al). Specifically, the bolts may be made of or coated with the silver, copper, gold, or aluminum. When the first electrode is of a different metal or metal composition than the second electrode, the portion(s) of the bolt(s) in contact with the electrodes are made of material having an electric conductivity that is no less than the lower of the electric conductivity of the first electrode and the electric conductivity of the second electrode. When the first electrode comprises a metal and the second electrode comprises a non-metal, the bolts can be made of material having an electric conductivity that is no less than that of the first electrode.

Arc discharge-preventing material may occupy space between the first and second electrodes. For example, a conductive film may be interposed between the first electrode and the second electrode. The conductive film comprises a material having an electric conductivity that is greater than that of the first electrode and the second electrode. Furthermore, the surfaces of the first electrode and the second electrode may be entirely coated with a material having an electric conductivity greater than that of the first electrode and the second electrode. Thus, electrical resistance between the electrodes is reduced.

The arc discharge-preventing material may be comprise the conductive film and filling material formed between at least one of the electrodes and the conductive film. Still further, the arc discharge-preventing material may consist of an adhesive or an anisotropic conductive film.

The arc discharge-preventing material can fill up a plurality of minute apertures or pits present in one or both of the confronting surfaces of the first and second electrodes, thereby ridding the assembly of spaces that may facilitate the generation of arcing.

To this end, an amorphous material is provided between the surfaces of the first and second electrodes that face towards one another, and the amorphous material is forced into pits that are present in the surfaces. For instance, a film of resin adhesive is interposed between the electrodes, and is subjected to heat and pressure. When a conductive film is used in conjunction with a resin adhesive, the film itself may be deformed and forced by the resin into the minute recesses or pits.

### BRIEF DESCRIPTION OF THE DRAWINGS

The above and other objects, features and advantages of the present invention will become more apparent from the following detailed description of the preferred embodiments thereof made with reference to the attached drawings, in which:

FIG. 1 is a cross-sectional view of a conventional electrode assembly;

FIG. 2 is a photograph showing a surface of the conventional electrode assembly damaged by an abnormal discharge;

FIG. 3 is an enlarged view of portion A of the photograph of FIG. 2;

FIG. 4 is a enlarged view of the contacting portions of the first electrode and the second electrode shown in FIG. 1;

FIG. 5 is a cross-sectional view of an embodiment of an electrode assembly according to the present invention;

FIG. 6 is an exploded perspective view of the electrode assembly shown in FIG. 5;

FIG. 7 is a perspective view of the second electrode of the electrode assembly shown in FIG. 5;

FIGS. 8A to 8D are enlarged views showing contacting portions of the first electrode and the second electrode of the electrode assembly shown in FIG. 5;

FIGS. 9A and 9B are enlarged views of contacting portions of the first electrode and the second electrode of another embodiment of an electrode assembly according to the present invention;

FIG. 10 is a cross-sectional view of another embodiment of an electrode assembly according to the present invention;

FIG. 11 is a schematic diagram of a processing apparatus for processing a semiconductor substrate according to the present invention;

FIGS. 12A to 12D are graphs showing the number of particles generated during an etching process performed by the processing apparatus shown in FIG. 11; and

FIGS. 13A to 13B are graphs showing the number of particles and a passing rate of the particles generated during an etching process performed by the processing apparatus shown in FIG. 11.

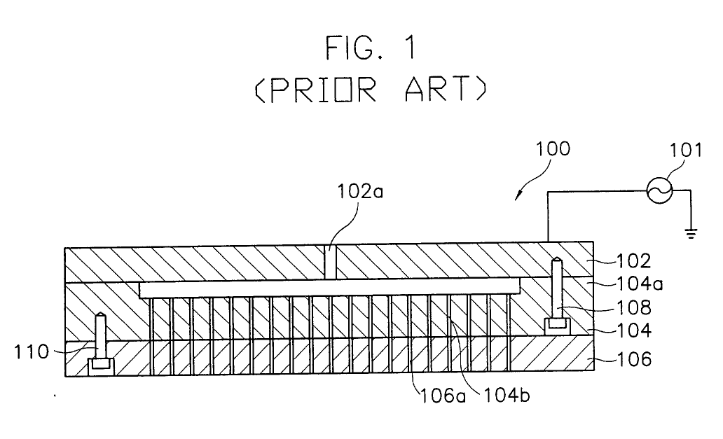

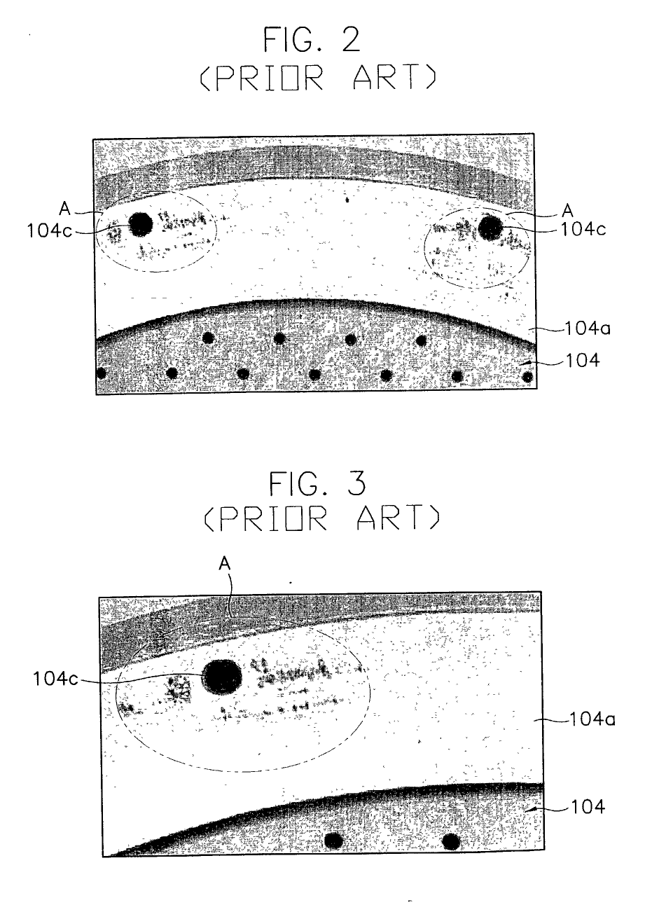

### DETAILED DESCRIPTION OF THE PREFERRED EMBODIMENTS

Hereinafter, preferred embodiments of the present invention will be described in detail with reference to accompanying drawings.

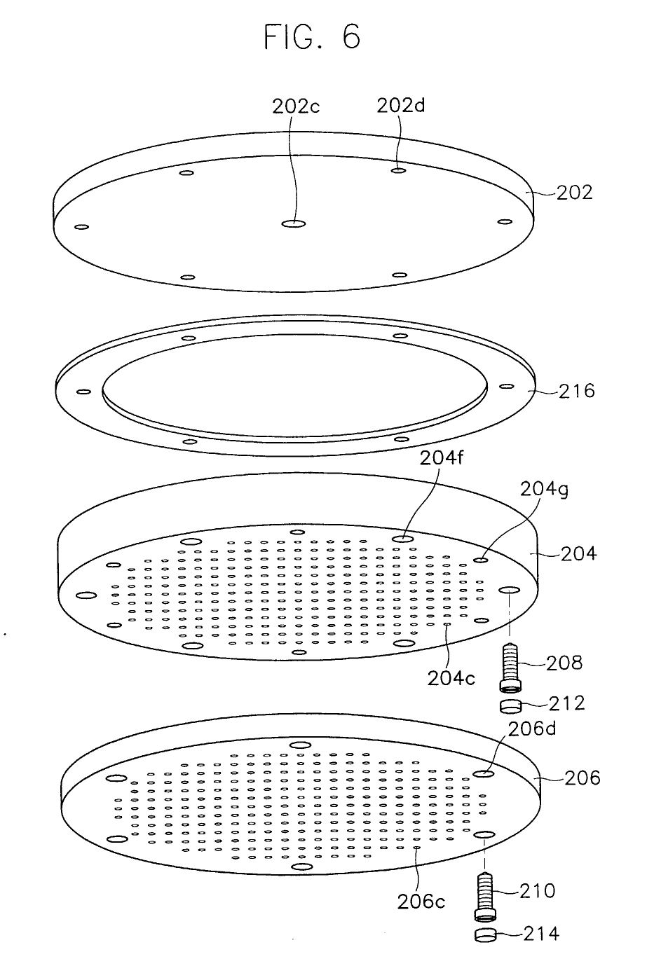

Referring first to FIGS. 5 and 6, a first electrode 202 having the form of a disk is connected to an RF electric power source 201. A first penetrating hole 202c, through which process gases for processing a semiconductor substrate pass, is formed at a central portion of the first electrode 202. A second electrode 204 in the form of a disk has the same diameter as the first electrode 202. The second electrode 204 has a first surface 204a that faces the first electrode 202, and a combining portion 204d that protrudes along the peripheral portion of the first surface 204a as disposed in contact with the first electrode 202. A plurality of second penetrating holes 204c extend through the second electrode 204 as arrayed uniformly across the entire first surface 204a thereof, i.e., across the central portion 204e of the second electrode 204 that is located radially inwardly of the combining portion 204d. The second penetrating holes 204c receive the process gases that flow through the first penetrating hole 202c and serve to uniformly supply the process gases into the processing chamber (not shown in the figure). A third electrode 206 is integrated with the second electrode 204 as disposed in contact with a second surface 204b thereof. The third electrode 206 has the form of a disk, and includes a plurality of third penetrating holes 206c corresponding to the second penetrating holes 204c, respectively.

Preferably, both the first electrode 202 and the second electrode 204 comprise aluminum (Al), and the third electrode (206) comprises silicon (Si). Furthermore, although the electrode assembly 200 has been described as comprising the first 202, second 204 and third 206 electrodes, the electrode assembly may employ only the first 202 and second 204 electrodes.

A gas supply part for supplying the process gases is disposed on a first surface 202a of the first electrode 202 so that the gases will flow through the first penetrating hole 202c. A plurality of first screw holes 202d are formed in a peripheral portion of a second surface 202b of the first electrode 202 that faces the combining portion 204d. A plurality of first combining holes 204f, corresponding to the first screw holes 202d, respectively, extend through the combining portion 204d. Each of the first combining holes 204f is countersunk from the second surface 204b of the second electrode 204 so as to accommodate both portions of a first bolt 208, i.e., the body portion and the head portion of the bolt.

A plurality of second screw holes 204g are formed in a peripheral portion of the second surface 204b of the second electrode 204 as spaced from the first combining holes 204f. A plurality of second combining holes 206d, corresponding to the second screw holes 204g of the second electrode 204, respectively, extend through the third electrode 206 along a peripheral portion of the third electrode 206. Each of the second combining holes 206d is countersunk from the second surface 206b of the third electrode 206 in the same manner as the first combining holes 204f. A plurality of second bolts 210 are threaded to the second screw holes 204g through the second combining holes 206d.

A plurality of first caps 212 are disposed in the first combining holes 204f for protecting each of the first bolts 208. A plurality of second caps 214 are disposed in the second combining holes 206d for protecting each of the second bolts 210.

The lower the electrical resistance is at the contacting portions of the first electrode 202, the second electrode 204, the third electrode 206, the first bolts 208, and the second bolts 210, the less likely an arc discharge will occur. Therefore, each of the first and the second bolts 208 and 210 is formed of a highly electrically conductive material, such as silver (Ag), copper (Cu), gold (Au) or aluminum (Al). Alternatively, the first bolts 208 and the second bolts 210 may be coated with a highly conductive material such as silver (Ag), copper (Cu), gold (Au) or aluminum (Al). In either case, the first bolts 208 and the second bolts 210 comprise a material having an electrical conductivity that is no less than that of the first electrode 202 and the second electrode 204, whereby the arc discharge is sufficiently prevented.

In addition, all of the surfaces of the first electrode 202 and the second electrode 204 can be coated with material having an electrical conductivity greater than that of the base material of the first electrode 202 and the second electrode 204 so as to prevent an arc discharge from occurring in minute apertures between the first electrode 202 and the second electrode 204. In particular, an abnormal discharge can be effectively prevented by coating the surfaces of the first electrode 202 and the second electrode 204 with material such as silver (Ag), copper (Cu), or gold (Au). Alternatively, a conductive film 216, comprising a highly electrically conductive metal, such as silver (Ag), copper (Cu), or gold (Au), can be interposed between the first electrode 202 and the second electrode 204.

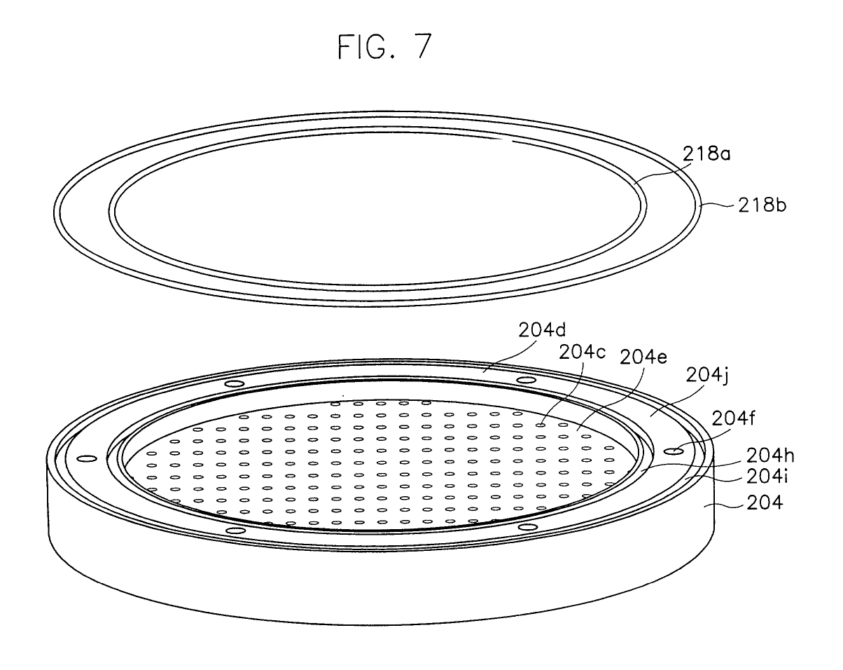

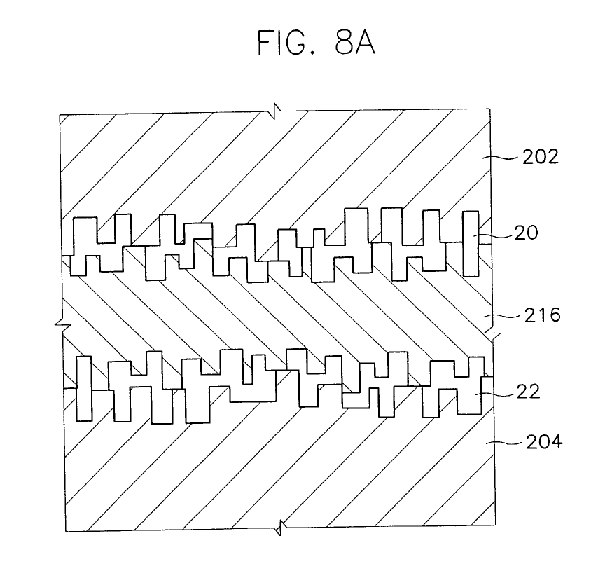

Referring now to FIGS. 5 and 7, the second electrode 204 has a first groove 204h and a second groove 204i formed in the surface 204j of the combining portion 204d so as to face the first electrode 202. The first groove 204h extends along an inner peripheral portion of the combining portion 204d, and the second groove 204i extends along an outer peripheral portion of the combining portion 204d. Also, the first combining holes 204f are located between the first groove 204h and the second groove 204i. A first sealing member 218a and a second sealing member 218b are inserted into the first groove 204h and the second groove 204i, respectively, for preventing particles, which are generated around the first bolts 208 by arc discharges, from migrating into the gas flow passages. Preferably, the first and the second sealing members 218a and 218b are O-rings, but various types of packings can be used.

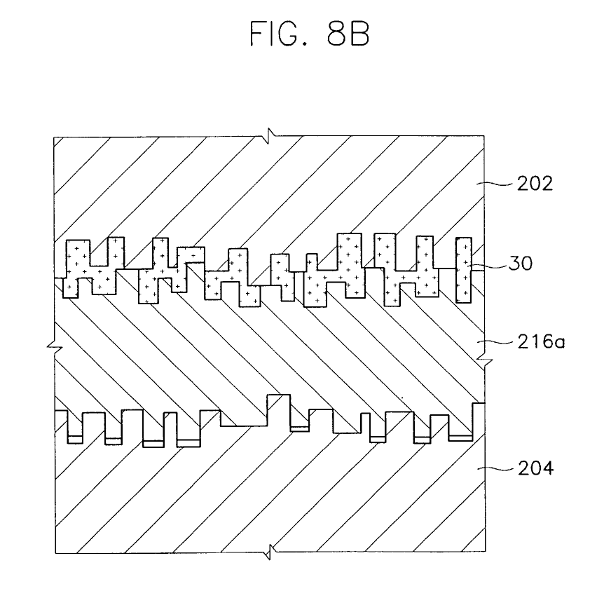

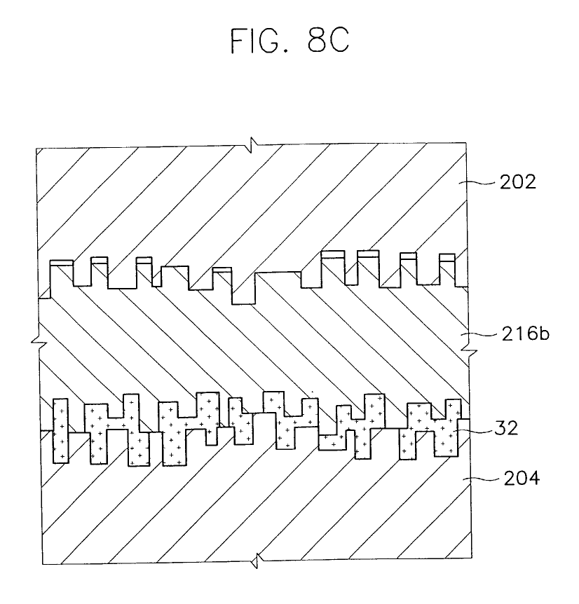

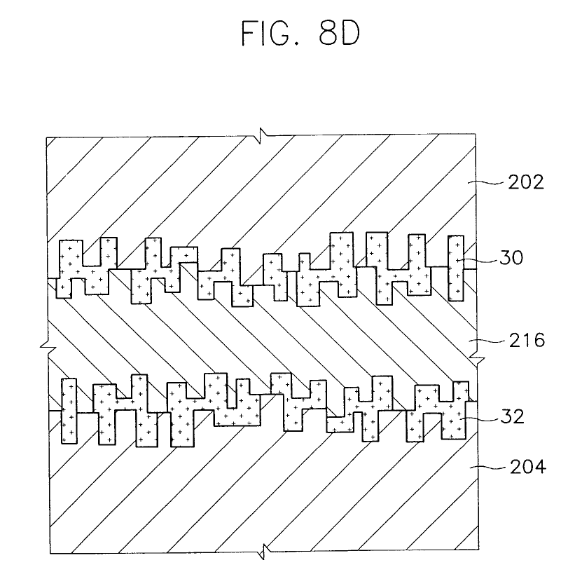

Referring now to FIG. 8A, the conductive film 216 having an electric conductivity greater than that of the first and the second electrode 202 and 204 is interposed between the first and the second electrode 202 and 204. First minute apertures are present between the first electrode 202 and the conductive film 216, and second minute apertures are present between the second electrode 204 and the conductive film 216. Although the conductive film 216 reduces the electrical resistance between the first electrode 202 and the second electrode 204, arc discharge may still be produced due to the first apertures 20 and the second apertures 22.

Referring to FIG. 8B, the first apertures 20 are filled with a first filling material 30. Therefore, the conductive film 216 is deformed by the resultant force that is exerted thereon by the first filling material 30, the first electrode 202, and the second electrode 204. The deformed conductive film 216a fills the second apertures 22 that had been present between the second electrode 204 and the conductive film 216. That is, the first apertures are filled with the first filling material 30 so that the discharge spaces corresponding to the first apertures no longer exist, and the second apertures 22 are occupied by the deformed conductive film 216a so that the discharge spaces corresponding to the second apertures no longer exist.

Referring to FIG. 8C, the second apertures 22 may instead be filled with second filling material 32. In a manner similar to that described with reference to FIG. 8b, the first apertures 20 become occupied by the deformed conductive film 216a so that the discharge spaces corresponding to the first apertures no longer exist, and the second apertures 22 are filled with the second filling material 32 so that the discharge spaces corresponding to the second apertures no longer exist.

However, the discharging spaces corresponding to the first and the second apertures 20 and 22 may not be sufficiently removed when the first apertures 20 and the second apertures 22 are filled with the deformed conductive film 216a, as shown in FIGS. 8B and 8C. Accordingly, as shown in FIG. 8D, the first apertures 20 and the second apertures 22 are preferably filled with the first and the second filling material 30 and 32, respectively.

The first filling material 30 and the second filling material 32 can be an adhesive applied to one or both sides of the conductive film 216. The adhesive may be a thermosetting resin, such as an epoxy, polyurethane, or acryl resin or a thermoplastic resin, such as a polyethylene or a polypropylene resin. Still further, the adhesive may be in the form of a tape. Adhesive films of thermosetting resin or thermoplastic resin may be respectively interposed between the first electrode 202 and the conductive film 216, and between the second electrode 202 and the conductive film 216. The first electrode 202 and the second electrode 204 are then pressurized for 10 to 20 seconds at a temperature within a range of about 160° C. to 180° C. As a result, the first apertures 20 and the second apertures 22 are filled with the adhesive such that the discharge spaces corresponding to the first apertures 20 and second apertures 22 no longer exist. Any adhesive that oozes out from the sides of the first and second electrodes 202, 204 is preferably removed.

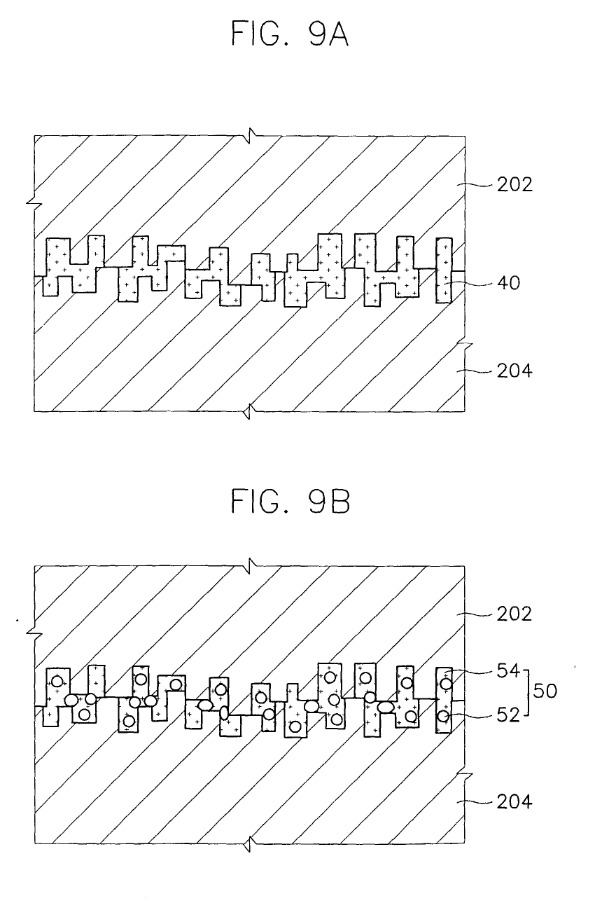

FIGS. 9A and 9B show the contacting portions of first and second electrodes of another embodiment of an electrode assembly according to the present invention.

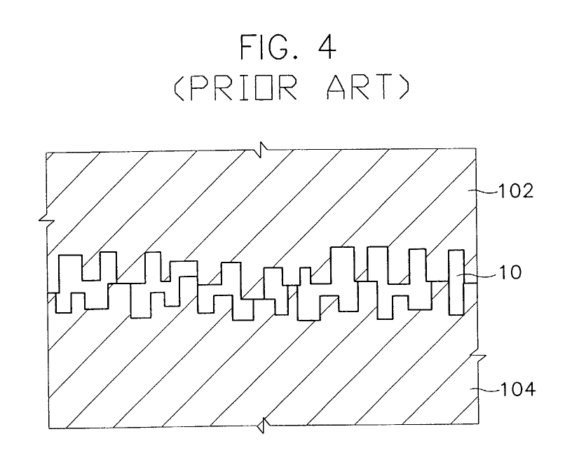

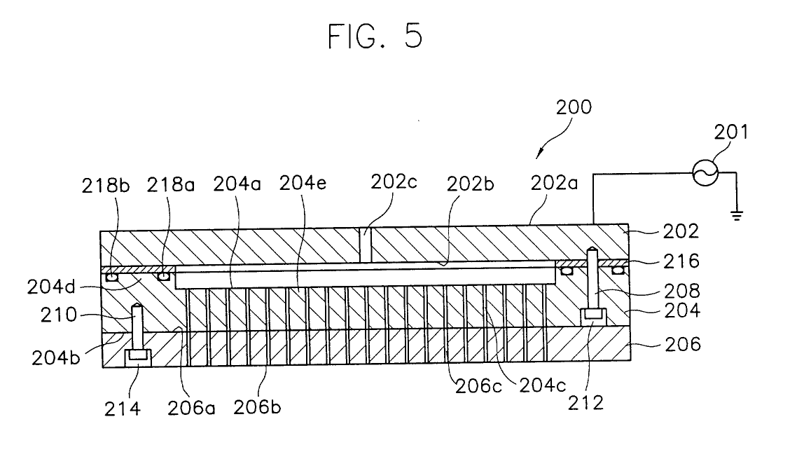

Referring to FIG. 9A, a filling material 40 fills the minute apertures formed between the first electrode 202 and the second electrode 204 (refer to FIG. 4) to prevented an arc discharge from occurring. Preferably, the filling material is an adhesive. In one embodiment, an adhesive film of thermosetting resin or thermoplastic resin is interposed directly between the first electrode 202 and the second electrode 204, whereupon heat and pressure are applied to the first electrode 202 and the second electrode 204. Therefore, the adhesive film is forced into the apertures. Consequently, the discharge spaces no longer exist, whereby arc discharge is prevented from occurring. In this embodiment, the first electrode 202 and the second electrode 204 are preferably coated with a metal having an electric conductivity greater than that of the first electrode 202 and the second electrode 204 themselves.

In the embodiment of FIG. 9B, the minute apertures formed between the first electrode 202 and the second electrode 204 are filled with an anisotropic conductive film 50 (hereinafter, referred to as an ACF). The ACF 50 includes conductive particles 52 randomly dispersed throughout an adhesive 54. The adhesive 54 may be a thermosetting resin, such as an epoxy, polyurethane, or acryl resin, or a thermoplastic resin, such as a polyethylene or polypropylene resin.

When the ACF 50 is interposed between the first electrode 202 and the second electrode 202, and then the first electrode 202 and the second electrode 204 are pressurized for 10 to 20 seconds at a temperature in a range of about 160° C. to 180° C., the apertures are filled with the adhesive 54. In addition, the first electrode 202 and the second electrode 204 are electrically conductively connected by the conductive particles 52. Here, the electric conductivity of the conductive particles 52 is preferably greater than that of the first electrode 202 and the second electrode 204 so that the electrical resistance between the first electrode 202 and the second electrode 204 is lowered.

An arc discharge between the first electrode 202 and the second electrode 204 is prevented because the conductive film 216 or the conductive particles 52 having an electric conductivity greater than that of the first electrode 202 and the second electrode 204 act to reduce the electrical resistance between first electrode 202 and the second electrode 204. Furthermore, minute apertures no longer exist between first electrode 202 and the second electrode 204, whereby an arc discharge is completely prevented from occurring between the first electrode 202 and the second electrode 204.

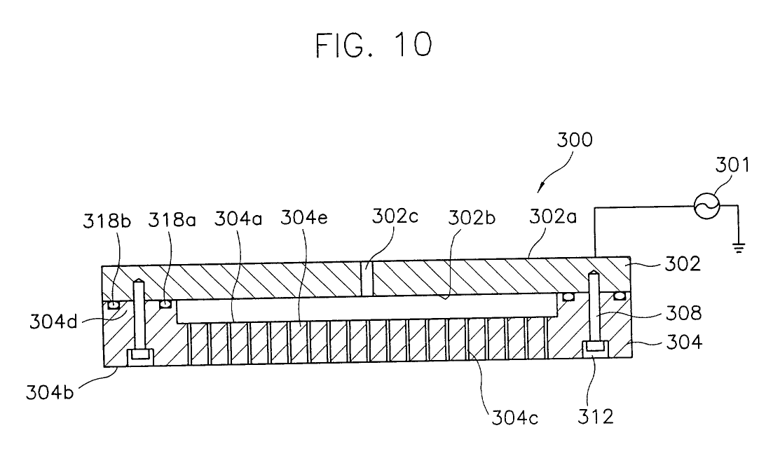

FIG. 10 shows another embodiment of an electrode assembly 300 according to the present invention.

Referring to FIG. 10, a first electrode 302 having the form of a disk is connected to an RF electric power source 301. A first penetrating hole 302c, through which process gases for processing a semiconductor substrate pass, is formed at a central portion of the first electrode 302. A second electrode 304 in the form of a disk has the same diameter as the first electrode 302. The second electrode 304 has a first surface 304a that faces the first electrode 302, and a combining portion 304d that protrudes along the peripheral portion of the first surface 304a as disposed in contact with the first electrode 302. A plurality of second penetrating holes 304c extend through the second electrode 304 as arrayed uniformly across the entire first surface 304a thereof, i.e., across the central portion 304e of the second electrode 304 that is located radially inwardly of the combining portion 304d. The second penetrating holes 304c receive the process gases that flow through the first penetrating hole 302c and serve to uniformly supply the process gases into the processing chamber (not shown in the figure). Preferably, the first electrode 302 comprises aluminum (Al), and the second electrode 304 comprises silicon (Si).

A gas supply part for supplying the process gases is disposed on a first surface 302a of the first electrode 302 so that the gases will flow through the first penetrating hole 302c. A plurality of screw holes are formed in a peripheral portion of a second surface 302b of the first electrode 302 that faces the combining portion 304d. A plurality of combining holes, corresponding to the screw holes, respectively, extend through the combining portion 304d. Each of the combining holes is countersunk from the second surface 304b of the second electrode 304 so as to accommodate both portions of a bolt 308, i.e., the body portion and the head portion of the bolt. A plurality of caps 312 are disposed in the combining holes for protecting each of the bolts 308.

The lower the electrical resistance is at the contacting portions of the first electrode 302 and the bolts 308, the less likely an arc discharge will occur. Therefore, each of the bolts 308 is formed of a highly electrically conductive material, such as silver (Ag), copper (Cu), gold (Au) or aluminum (Al). Alternatively, the bolts 308 may be coated with a highly conductive material such as silver (Ag), copper (Cu), gold (Au) or aluminum (Al). In either case, the bolts 308 comprise a material having an electrical conductivity that is no less than that of the first electrode 302, whereby the arc discharge is sufficiently prevented.

The second electrode 304 has a first groove and a second groove formed in the surface of the combining portion 304d so as to face the first electrode 302. The first groove extends along an inner peripheral portion of the combining portion 304d, and the second groove extends along an outer peripheral portion of the combining portion 304d. Also, the combining holes are located between the first groove and the second groove. A first sealing member 318a and a second sealing member 318b are inserted into the first groove and the second groove, respectively, for preventing particles, which are generated around the bolts 308 by arc discharges, from migrating into the gas flow passages. Preferably, the first and the second sealing members 318a and 318b are O-rings, but various types of packings can be used.

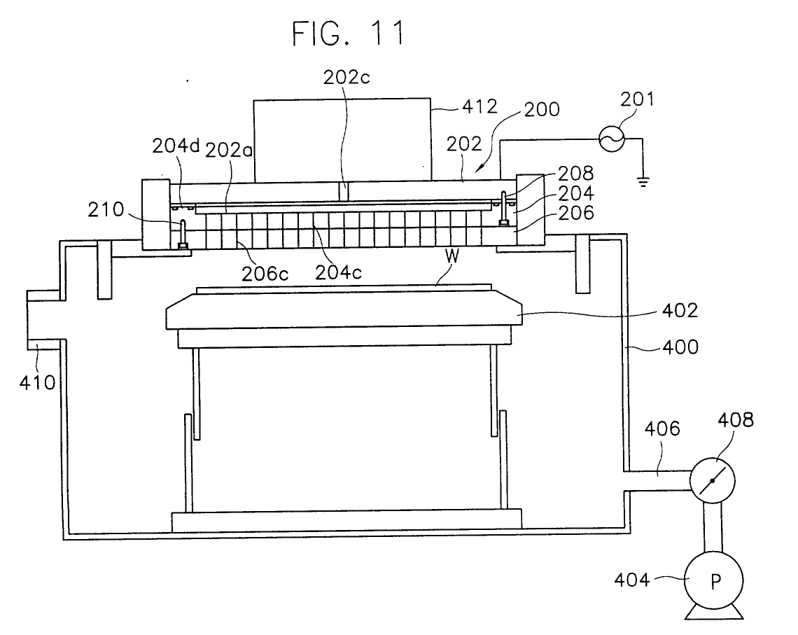

FIG. 11 shows a processing apparatus, including the electrode assembly 200 shown in FIG. 5, for processing semiconductor substrates W.

Referring to FIG. 11, the processing apparatus includes a processing chamber 400 in which a semiconductor substrate (W) is processed, a chuck 402 for supporting the semiconductor substrate (W) in the processing chamber 400, an electrode assembly 200 disposed at an upper portion of the processing chamber 400 for supplying process gases into the chamber 400 and for transforming the process gases into a plasma, and a gas supply part 412 by which the process gases are supplied to the electrode assembly 200. The electrode assembly 200 is connected to an RF electric power source 201. A vacuum pump 404 is connected to one side of the processing chamber 400 through an outlet line 406 for exhausting by-products generated during the processing of the semiconductor substrate (W) and non-reactive process gases remaining in the chamber 400 during the process. A pressure control valve 408 is installed in the outlet line 406 for controlling the pressure within the processing chamber 400. A door 410 is disposed at the other side of the processing chamber 400 for allowing the semiconductor substrate (W) to be transferred into and out of the chamber 400. Also, the chuck 402 can be shifted between loading and unloading positions, and the illustrated position at which the semiconductor substrate (W) is processed.

The first and second electrodes 202 and 204 of the electrode assembly 200 are made of aluminum (Al), and the third electrode 206 is made of silicon (Si). The first bolts 208 that connect the first electrode 202 and the second electrode 204, and the second bolts 210 that connect the second electrode 204 and the third electrode 206, may each be made of aluminum (Al). However, the first and the second blots 208 and 210 preferably comprise a metal having an electric conductivity greater than that of aluminum (Al), or can be made of stainless steel coated with a highly electrically conductive metal, such as silver (Ag), copper (Cu), gold (Au), or aluminum (Al).

The above-described processing apparatus can be used for carrying out a deposition process for depositing a layer of material on the semiconductor substrate W, or an etching process for removing some of the material from a layer that has already been formed on the semiconductor substrate W. The temperature of the substrate and the pressure within the processing chamber are established based on whether the deposition process or the etching process is being performed.

An example of the deposition process is as follows. A semiconductor substrate W is positioned on the chuck 402. A polysilicon layer has been previously formed on the semiconductor substrate W. The substrate W is heated to 600° C., and the pressure within the processing chamber 400 is set to 1,250 Torr. Then, RF electric power is supplied to the electrode assembly 200, and the process gases are supplied into the processing chamber 400 through the gas supply part 412 and the electrode assembly 200. The process gases may include silane (SiH4) and tungsten hexafluoride (WF6), and are transformed into a plasma by the RF electric power supplied to the electrode assembly 200. The plasma transforms a portion of the polysilicon layer into silicide, and then the silicide is, in turn, transformed into a tungsten silicide layer on the semiconductor substrate W.

An example of the etching process is as follows. The semiconductor substrate W is positioned on the chuck 402 in the processing chamber 400. An oxide layer and a photoresist pattern as an etching mask have been previously formed on the semiconductor substrate. Then, the pressure within the processing chamber is set to 100 mTorr, and an RF electric power of 600W is supplied to the electrode assembly 200. Subsequently, process gases, such as CHF3 and CF4, are supplied into the processing chamber 400 through the gas supply part 412 and the electrode assembly 200. Accordingly, part of the oxide layer is etched away. In particular, a contact hole may be formed in the oxide layer.

During the described deposition or etching process, the plasma includes only an extremely small quantity of particulate contaminants because the highly electrically conductive structural members and conductive film of the electrode assembly 200 prevent arc discharges from occurring. Accordingly, the process gases are steadily transformed into the plasma, and therefore, a high-quality semiconductor substrate can be fabricated in the processing chamber.

In order to evaluate the performance of the electrode assembly, several experiments were performed as follows.

Experiment 1

Etching processes for forming a self-aligned contact hole (hereinafter, referred to as SAC) were carried out using etching apparatus having a conventional electrode assembly (first electrode assembly). Specifically, the conventional electrode assembly included first and the second electrodes of aluminum (Al), a third electrode of silicon (Si), and stainless steel bolts connecting the first, second and third electrodes. In addition, another series of SAC etching processes were carried out using etching apparatus having an electrode assembly according to the present invention (second electrode assembly). In this assembly, the first and the second electrodes were of aluminum (Al), the third electrode was of silicon (Si), and aluminum (Al) bolts connected the first, second and third electrodes.

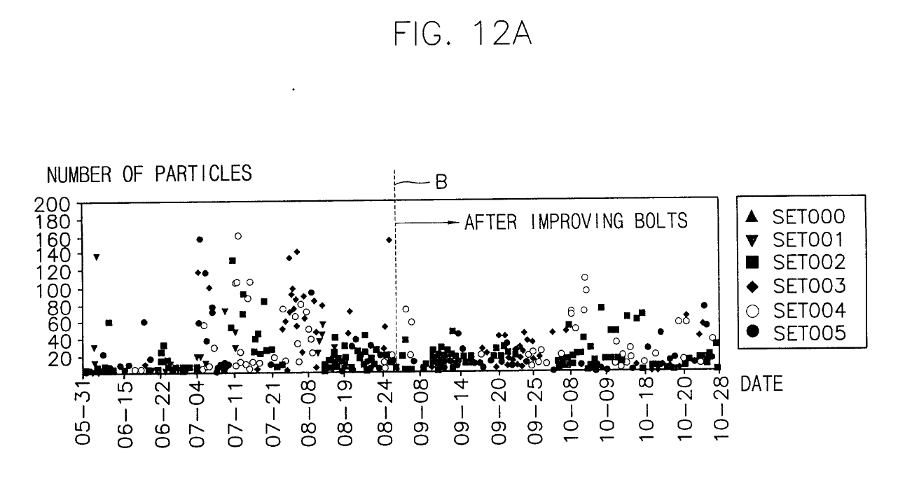

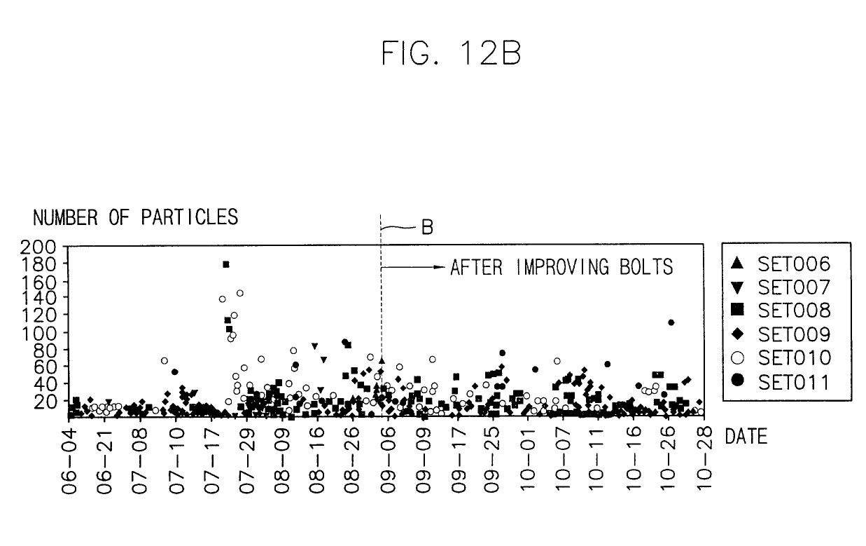

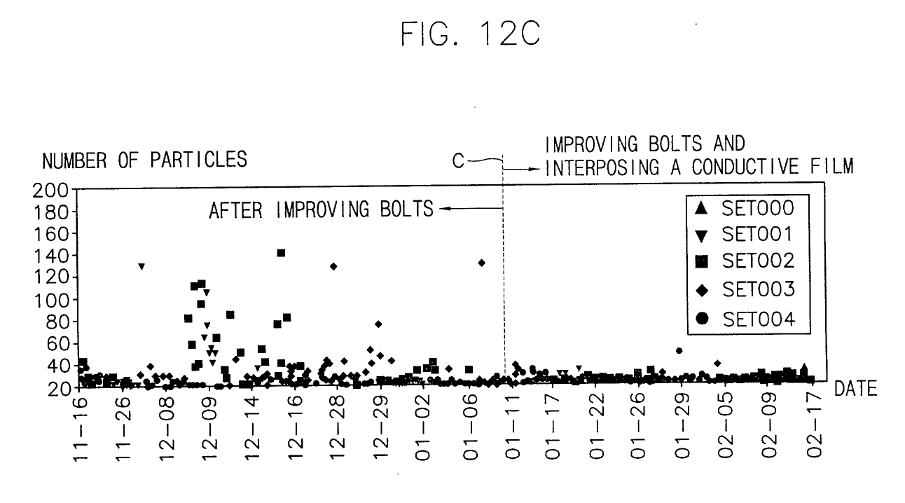

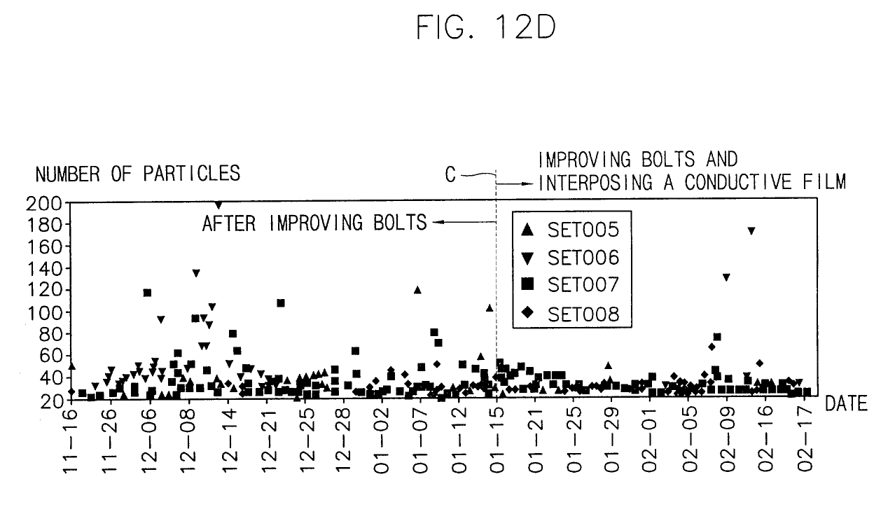

The SAC etching processes were performed from May 31, 2001 to Oct. 28, 2001, and the numbers of particles remaining on the substrates were measured using a scatterometric particle measurement system manufactured by Kla-Tencor Co., U.S.A. The experimental results are shown in FIG. 12A.

Experiment 2

Etching processes for forming a capacitor having a one cylinder stack (hereinafter, referred to as OCS) structure were carried using etching apparatus having the conventional (first) electrode assembly as described in connection with Experiment 1. Etching processes for forming the OCS capacitor (hereinafter, referred to as OCS etching) were also carried out using etching apparatus having the second electrode assembly according to the present invention, i.e., as described in connection with Experiment 1.

The OCS etching processes were performed from Jun. 4, 2001 to Oct. 28, 2001, and the numbers of particles remaining on the substrates were also measured using the scatterometric particle measurement system manufactured by Kla-Tencor Co., U.S.A. The experimental results are shown in FIG. 12B.

Experiment 3

SAC etching processes were carried out using an etching apparatus having the second electrode assembly as described in connection with Experiment 1. In addition, SAC etching processes were also carried out using etching apparatus having another electrode assembly (third electrode assembly) according to the present invention. The third electrode assembly included first and second electrodes of aluminum (Al), a third electrode of silicon (Si), aluminum (Al) bolts connecting the first, second and third electrodes, and a conductive film of copper (Cu) interposed between the first electrode and the second electrode.

The SAC etching processes were performed from Nov. 16, 2001 to Feb. 17, 2002, and the numbers of particles remaining on the substrates were measured using the scatterometric particle measurement system manufactured by Kla-Tencor Co., U.S.A. The experimental results are shown in FIG. 12C.

Experiment 4

OCS etching processes were performed using etching apparatus having the second electrode assembly as described in connection with Experiment 1. In addition, OCS etching processes were performed using etching apparatus having the third electrode assembly as described in connection with Experiment 3.

The OCS etching processes were performed from Nov. 16, 2001 to Feb. 17, 2002, and the numbers of particles remaining on the substrates were also measured using the scatterometric particle measurement system manufactured by Kla-Tencor Co., U.S.A. The experimental results are shown in FIG. 12D.

Experiment 5

Both SAC etching processes and OCS etching processes were performed using etching apparatus having the first electrode assembly described in connection with Experiment 1.

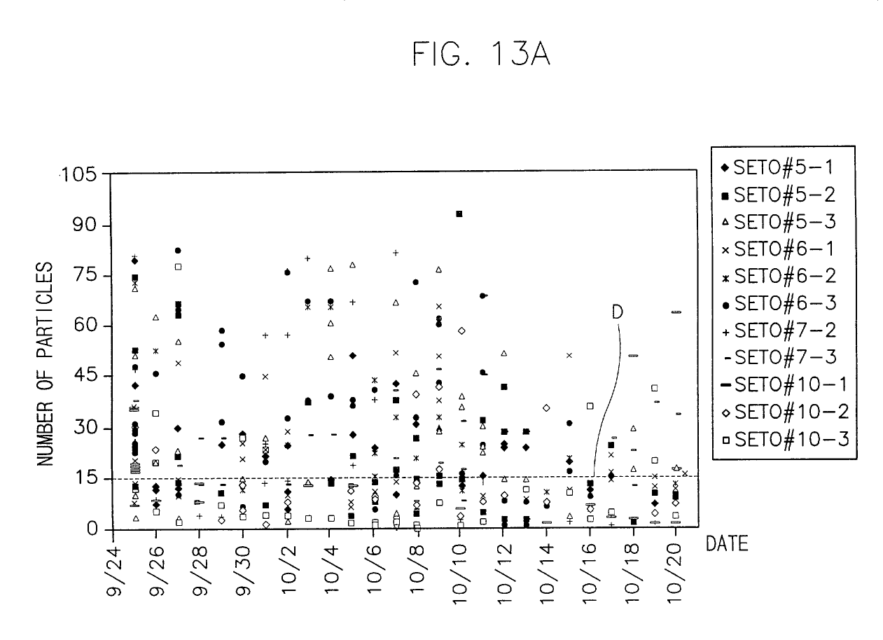

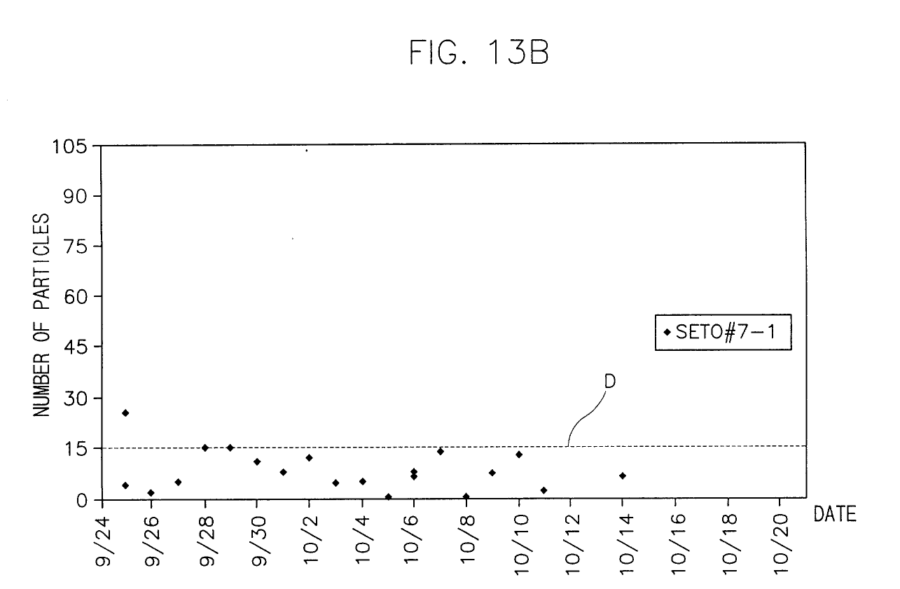

The SAC and OCS etching processes were performed from Sep. 24, 2001 to Oct. 20, 2001, and the numbers of particles remaining on the substrates were also measured using the scatterometric particle measurement system manufactured by Kla-Tencor Co., U.S.A. The experimental results are shown in FIG. 13A.

Experiment 6

Both SAC etching processes and OCS etching processes were performed using etching apparatus having the second electrode assembly as described in connection with Experiment 1.

The SAC and OCS etching processes were performed from Sep. 24, 2001 to Oct. 20, 2001, and the numbers of particles remaining on the substrates were also measured using the scatterometric particle measurement system manufactured by Kla-Tencor Co., U.S.A. The experimental results are shown in FIG. 13B.

Referring to FIGS. 12A and 12B, the left portions of the figures (to the left of dotted line B) show the number of particles when the SAC etching processes and the OCS etching processes were performed using the etching apparatus having the first conventional electrode assembly, whereas the right portions of the figures (to the right of dotted line B) show the number of particles when the SAC etching processes and the OCS etching processes were performed using the etching apparatus having the second electrode assembly. Also, the notations in the key of the figures indicate serial numbers of the etching apparatus used in the experiments.

The effect of the present invention is evident from the figures. That is, comparing the left and the right portions of the figures reveals that the arc discharge between the electrode assembly and the bolts is reduced when using an electrode assembly according to the present invention.

FIGS. 12C and 12D also show the effect of the present invention. The left portions of the figures (to the left of dotted line C) show the number of particles when both the SAC etching processes and the OCS etching processes were performed in the etching apparatus having the second electrode assembly, whereas the right portions of the figures show the number of particles when both the SAC etching processes and the OCS etching processes were performed in etching apparatus having the third electrode assembly. Again, the notations in the key of the figures indicate serial numbers of the etching apparatus used in the experiments.

Comparing the left and the right portions of the figures reveals that the arc discharge between the electrode assembly and the bolts is even further reduced by using the ACF.

FIG. 13A shows the number of particles when both the SAC etching processes and the OCS etching processes were performed using etching apparatus having the first (conventional) electrode assembly, and FIG. 13B shows the number of particles when both the SAC etching processes and the OCS etching processes were performed using the etching apparatus having the second electrode assembly.

Also, a passing ratio can be discerned from each of FIGS. 13A and 13B. The passing ratio is defined as the ratio of the number of substrates on which the number of particles is less than an allowable number (represented by line D in the figures) to the total number of substrates. When the etching apparatus having the conventional electrode assembly were used, the passing ratio was merely 51%. This can be attributed to frequent arc discharges. However, when the etching apparatus having the second electrode assembly was used, the passing ratio is greatly improved, i.e., is 95%, because arc discharges are inhibited. Also, whereas the average number of particles on a substrate was 23 when using the conventional electrode assembly, the average number of particles on a substrate was 8 when using the second electrode assembly.

According to the present invention, a plurality of bolts having an electric conductivity no less than that of the electrodes which they connect prevent arc discharges from occurring between the electrodes and the bolts. Furthermore, a conductive film having an electric conductivity greater than that of the electrodes and interposed between the electrodes can also prevent arc discharges from occurring between the electrodes. Still further, a filling material fills minute apertures formed between the conductive film and the electrode, and between the electrodes, thereby ridding the assembly of discharge spaces to in turn fully prevent arc discharges from occurring between the conductive film and the electrode, and between the electrodes. Accordingly, the electrode assembly does not create particles that can contaminate the substrate, and the process gases for processing the semiconductor substrate can be steadily transformed into plasma by the electrode assembly.

Finally, although the present invention has been described in detail above, various changes, substitutions and alterations can be made thereto without departing from the true spirit and scope of the invention as defined by the appended claims.

What is claimed is:

1. An electrode assembly for use in processing a substrate, comprising:
a first electrode having a first surface;
a second electrode facing said first electrode; and
a first fastener connecting said first electrode and said second electrode, said first fastener having a contacting portion at which the fastener makes contact with said first electrode and said second electrode, and the contacting portion of said first fastener being of a first material having an electric conductivity that is no less than the lower of the electric conductivity of said first electrode and the electric conductivity of said second electrode.

2. The electrode assembly as claimed in claim 1, wherein said first electrode and said second electrode comprise aluminum (Al), and said first material is selected from the group consisting of silver (Ag), copper (Cu), gold (Au) and aluminum (Al).

3. The electrode assembly as claimed in claim 1, wherein said first fastener is a bolt of said first material.

4. The electrode assembly as claimed in claim 1, wherein said first fastener is a bolt coated over the entire surface thereof with said first material.

5. The electrode assembly as claimed in claim 1, wherein said first electrode has is the form of a disk and includes a first penetrating hole extending through a central portion thereof for supplying process gas into a processing chamber, and
said second electrode has the form of a disk corresponding to said first electrode, said second electrode having a central first surface facing said first electrode, a combining portion constituting a protrusion extending towards said first electrode along the periphery of said first surface, and second penetrating holes extending axially therethrough and arrayed uniformly across said first surface, the second penetrating holes communicating with said first penetrating hole for uniformly supplying the process gas into the processing chamber.

6. The electrode assembly as claimed in claim 5, and further comprising a plurality of seals disposed on an inner peripheral portion and an outer peripheral portion of said combining portion of the second electrode, respectively.

7. The electrode assembly as claimed in claim 5, and further comprising a third electrode disposed on a second surface of said second electrode that is opposite to said first surface, said third electrode having a plurality of third penetrating holes extending therethrough, said third penetrating holes corresponding to said second penetrating holes and communicating therewith, respectively; and
said second fastener having a contacting portion at which the second fastener makes contact with said second electrode and said third electrode, and the contacting portion of said second fastener being of a second material having an electric conductivity that is no less than the electric conductivity of said second electrode.

8. The electrode assembly as claimed in claim 7, wherein said second electrode comprises aluminum (Al), and said second material is selected from the group consisting of silver (Ag), copper (Cu), gold (Au) and aluminum (Al).

9. The electrode assembly as claimed in claim 7, wherein said second fastener is a bolt of said second material.

10. The electrode assembly as claimed in claim 7, wherein said second
fastener is a bolt coated over the entire surface thereof with said second material.

11. The electrode assembly as claimed in claim 7, wherein said first electrode and said second electrode comprise aluminum (Al), and said third electrode comprises silicon (Si).

12. The electrode assembly as claimed in claim 1, wherein said first electrode and said second electrode are coated with a material having an electric conductivity no less than that of the material of said first electrode and said second electrode, respectively.

13. The electrode assembly as claimed in claim 12, wherein said first electrode and said second electrode comprise aluminum (Al), and the material coating the electrodes is selected from the group consisting of silver (Ag), copper (Cu), and gold (Au).

14. The electrode assembly as claimed in claim 1, and further comprising a conductive film interposed between said first electrode and said second electrode, said conductive film having an electric conductivity greater than each of those of said first electrode and said second electrode.

15. The electrode assembly as claimed in claim 14, wherein said first electrode and said second electrode comprise aluminum (Al), and said conductive film comprises a material selected from the group consisting of silver (Ag), copper (Cu), and gold (Au).

16. The electrode assembly as claimed in claim 14, and further comprising a first filling material occupying space between said first electrode and said conductive film as disposed in contact therewith.

17. The electrode assembly as claimed in claim 16, and further comprising a second filling material occupying space between said second electrode and said conductive film as disposed in contact therewith.

18. The electrode assembly as claimed in claim 17, wherein said first filling material and said second filling material each include an adhesive.

19. The electrode assembly as claimed in claim 14, and further comprising a filling material occupying space between said second electrode and said conductive film as disposed in contact therewith.

20. The electrode assembly as claimed in claim 1, and further comprising an anisotropic conductive film interposed between said first electrode and said second electrode, said anisotropic conductive film having a plurality of conductive particles scattered throughout the film, said conductive particles having an electric conductivity greater than each of those of said first electrode and said second electrode.

21. An electrode assembly for use in processing a substrate, comprising:
a first electrode that is to be connected to a source of radio frequency electrical power for transforming a process gas into plasma;
a second electrode facing said first electrode; and
a first fastener connecting said first electrode and said second electrode, said first fastener having a contacting portion at which the fastener makes contact with said first electrode and said second electrode, and the contacting portion of said first fastener being of a first material having an electric conductivity that is no less than that of said first electrode.

22. The electrode assembly as claimed in claim 21, wherein said first electrode comprises aluminum (Al), said second electrode comprises silicon (Si), and said material is selected from the group consisting of silver (Ag), copper (Cu), gold (Au), and aluminum (Al).

23. The electrode assembly as claimed in claim 21, wherein said fastener is a bolt of said material.

24. The electrode assembly as claimed in claim 21, wherein said fastener is a bolt coated over the entire surface thereof with said material.

25. An electrode assembly for use in processing a substrate, comprising:
a pair of adjacent electrodes comprising a first electrode having a first surface, and a second electrode having a first surface facing the first surface of said first electrode; and
a filling material for filling up a plurality of minute apertures between said first and second electrodes as disposed in contact therewith.

26. The electrode assembly as claimed in claim 25, wherein said filling material includes an adhesive.

27. The electrode assembly as claimed in claim 25, wherein said filling material includes a conductive film having an electric conductivity greater than each of those of said first electrode and said second electrode, and an adhesive disposed on at least one side surface of said conductive film.

28. The electrode assembly as claimed in claim 25, wherein said filling material includes an anisotropic conductive film in which a plurality of conductive particles are scattered, said conductive particles having an electric conductivity greater than those of said first electrode and said second electrode.

29. The electrode assembly as claimed in claim 25, and further comprising a fastener connecting said first electrode and said second electrode, said first fastener having a contacting portion at which the fastener makes contact with said first electrode and said second electrode, and the contacting portion of said first fastener being of a first material having an electric conductivity that is no less than the lower of the electric conductivity of said first electrode and the electric conductivity of said second electrode.

30. The electrode assembly as claimed in claim 29, wherein said first electrode and said second electrode comprise aluminum (Al), and said first material is selected from the group consisting of silver (Ag), copper (Cu), gold (Au), and aluminum (Al).

31. The electrode assembly as claimed in claim 29, wherein said fastener is a bolt of said first material.

32. The electrode assembly as claimed in claim 29, wherein said fastener is a bolt coated over the entire surface thereof with said first material.

33. An electrode assembly for use in processing a substrate, comprising:
a pair of adjacent electrodes comprising a first electrode having a first surface, and a second electrode having a first surface facing the first surface of said first electrode; and
arc discharge-preventing material occupying space between said first and second electrodes as disposed in contact therewith, the space including pits in the first surfaces of said adjacent first and second electrodes.

34. The electrode assembly as claimed in claim 33, wherein said arc discharge-preventing material includes an adhesive.

35. The electrode assembly as claimed in claim 33, wherein said arc discharge-preventing material includes a conductive film having an electric conductivity greater than each of those of said first electrode and said second electrode, and an adhesive disposed on at least one side surface of said conductive film.

36. The electrode assembly as claimed in claim 33, wherein said arc discharge-preventing material includes an anisotropic conductive film in which a plurality of conductive particles are scattered, said conductive particles having an electric conductivity greater than those of said first electrode and said second electrode.

37. The electrode assembly as claimed in claim 33, and further comprising a fastener connecting said first electrode and said second electrode, said first fastener having a contacting portion at which the fastener makes contact with said first electrode and said second electrode, and the contacting portion of said first fastener being of a first material having an electric conductivity that is no less than the lower of the electric conductivity of said first electrode and the electric conductivity of said second electrode.

38. The electrode assembly as claimed in claim 37, wherein said first electrode and said second electrode comprise aluminum (Al), and said first material is selected from the group consisting of silver (Ag), copper (Cu), gold (Au), and aluminum (Al).

39. The electrode assembly as claimed in claim 37, wherein said fastener is a bolt of said first material.

40. The electrode assembly as claimed in claim 37, wherein said fastener is a bolt coated over the entire surface thereof with said first material.

41. A processing apparatus for processing a substrate, comprising:
a processing chamber in which the substrate is to be processed;
a chuck disposed in said processing chamber and dedicated to support the substrate;
a gas supply part from which process gas is supplied;
a radio frequency electrical power source;
an electrode assembly disposed within said processing chamber, said electrode assembly including a first electrode that is connected to said high-frequency electrical power source and having a first penetrating hole extending therethrough and which hole communicates with said gas supply part so as to receive process gas therefrom, a second electrode that faces said first electrode and has a plurality of second penetrating holes therethrough that communicate with said first penetrating hole and the interior of said processing chamber so as to disperse process gas flowing through the penetrating hole of said first electrode into said processing chamber, and a first fastener connecting said first electrode and said second electrode, said first fastener having a contacting portion at which the fastener makes contact with said first electrode and said second electrode, and the contacting portion of said first fastener being of a first material having an electric conductivity that is no less than the lower of the electric conductivity of said first electrode and the electric conductivity of said second electrode; and
an exhaust system connected to said processing chamber so as to control the pressure within said processing chamber.

42. The processing apparatus as claimed in claim 41, a third electrode disposed on a second surface of said second electrode that is opposite to said first surface, said third electrode having a plurality of third penetrating holes extending therethrough, said third penetrating holes corresponding to said second penetrating holes and communicating therewith, respectively; and
said second fastener having a contacting portion at which the second fastener makes contact with said second electrode and said third electrode, and the contacting portion of said second fastener being of a second material having an electric conductivity that is no less than the electric conductivity of said second electrode.

43. The processing apparatus as claimed in claim 42, wherein said first electrode and said second electrode comprise aluminum (Al), and said third electrode comprises silicon (Si).

44. The processing apparatus as claimed in claim 41, wherein said electrode assembly further comprises a conductive film interposed between said first electrode and said second electrode, said conductive film having an electric conductivity that is greater than each of those of said first electrode and said second electrode.

45. The processing apparatus as claimed in claim 44, wherein said electrode assembly further comprises a first filling material occupying space between said first electrode and said conductive film as disposed in contact therewith.

46. The processing apparatus as claimed in claim 45, wherein said electrode assembly further comprises a second filling occupying space between said second electrode and said conductive film as disposed in contact therewith.

47. The processing apparatus as claimed in claim 46, wherein said first filling material and said second filling material each include an adhesive.

48. The processing apparatus as claimed in claim 44, wherein said electrode assembly further comprises a filling material occupying space between said second electrode and said conductive film as disposed in contact therewith.

49. The processing apparatus as claimed in claim 41, wherein said electrode assembly further comprises an anisotropic conductive film interposed between said first electrode and said second electrode, said film having a plurality of conductive particles scattered throughout the film, and said conductive particles having an electric conductivity that is greater than each of those of said first electrode and said second electrode.

50. A processing apparatus for processing a substrate, comprising:
a processing chamber in which the substrate is to be processed;
a chuck disposed in said processing chamber and dedicated to support the substrate;
a gas supply part from which process gas is supplied;
a radio frequency electrical power source;
an electrode assembly disposed within said processing chamber, said electrode assembly including a pair of adjacent electrodes comprising a first electrode and a second electrode facing said first electrode, and arc discharge-preventing material occupying space between said first and second electrodes as disposed in contact therewith, the space including pits in the first surfaces of said adjacent first and second electrodes,
said first electrode being connected to said high-frequency electrical power source and having a first penetrating hole extending therethrough and which hole communicates with said gas supply part so as to receive process gas therefrom, and said second electrode a plurality of second penetrating holes therethrough that communicate with said first penetrating hole and the interior of said processing chamber so as to disperse process gas flowing through the penetrating hole in said first electrode into said processing chamber; and
an exhaust system connected to said processing chamber so as to control the pressure within said processing chamber.

51. The processing apparatus as claimed in claim 50, wherein said arc discharge-preventing material includes an adhesive.

52. The processing apparatus as claimed in claim 50, wherein said arc discharge-preventing material includes a conductive film having an electric conductivity greater than those of said first electrode and said second electrode, and an adhesive disposed on at least one side surface of said conductive film.

53. The processing apparatus as claimed in claim 50, wherein said arc discharge-preventing material includes an anisotropic conductive film in which a plurality of conductive particles are scattered, said conductive particles having an electric conductivity that is greater than those of said first electrode and said second electrode.

54. The processing apparatus as claimed in claim 50, and further comprising a bolt connecting said first electrode and said second electrode, said bolt being of a material having a first electric conductivity that is no less than the lower of the electric conductivity of said first electrode and the electric conductivity of said second electrode.

55. The processing apparatus as claimed in claim 50, and further comprising a bolt connecting said first electrode with said second electrode, the bolt being coated over the entire surface thereof with a material having an electric conductivity that is no less than the lower of the electric conductivity of said first electrode and the electric conductivity of said second electrode.

56. In a method of making an electrode assembly for use in processing a substrate, the assembly including a first electrode to be connected to a source of radio frequency electrical power for transforming a process gas into plasma, and a second electrode facing the first electrode, the improvement comprising: providing an amorphous material between surfaces of the first and second electrodes that face towards one another and forcing the amorphous material into pits that are present in the surfaces, whereby the material rids the electrode assembly of potential spaces in which arc discharging could occur during use of the electrode assembly.

57. The improvement in a method of making an electrode assembly as claimed in claim 56, wherein the amorphous material comprises an adhesive.

58. The improvement in a method of making an electrode assembly as claimed in claim 56, wherein the amorphous material includes an electrically conductive film having an electric conductivity greater than those of said first electrode and said second electrode, and an adhesive disposed on at least one side surface of said conductive film.

59. The improvement in a method of making an electrode assembly as claimed in claim 56, wherein said amorphous material includes an anisotropic conductive film in which a plurality of electrically conductive particles are dispersed, said conductive particles having an electric conductivity greater than those of said first electrode and said second electrode.

60. The improvement in a method of making an electrode assembly as claimed in claim 56, wherein said amorphous material includes a resin, and the resin is subjected to heat and pressure.
